(19) United States
(12) Patent Application Publication
(10) Pub. No.: US 2005/0040122 A1
(43) Pub. Date: Feb. 24, 2005

(54) Arrangement for product display prongs

(75) Inventors: Bengt Ahlund, Sollentuna (SE); Marten Sjoberg, Stockholm (SE); Borje Josefsson, Sorberge (SE)

Correspondence Address: SUGHRUE MION, PLLC, 2100 PENNSYLVANIA AVENUE, N.W., SUITE 800, WASHINGTON, DC, 20037, US

(73) Assignee: HL Display AB, SE-128 34 Skarpnack (SE)

(21) Appl. No.: 10/503,895

(22) PCT Filed: Jan. 29, 2003
(86) PCT No.: PCT/SE03/00146

(30) Foreign Application Priority Data
Feb. 21, 2002 (SE) 0200513-0

(51) Int. Cl. B42F 1/00; A47F 5/08

(52) U.S. Cl. 211/59.1; 211/57.1; 211/106.01

(57) ABSTRACT

An arrangement for merchandise display prongs for displaying merchandise in shops and the like and including a cantilever arm for carrying the merchandise and a feed device which is displaceable along the arm and provided with a grip part. The feed device is intended, when acted on manually, to displace the merchandise carried by the arm in the forward direction toward its free end for the purpose of bringing about a favorable display of the merchandise. The cantilever arm is in the form of a profiled rail with a groove extending on the underside, in that the feed device is guided by the profiled rail and is made with an elongate maneuvering arm, in that the maneuvering arm runs in a protected manner in the groove in the profiled rail, and in that a guide element for the maneuvering arm is arranged at the front end of the profiled rail.

### FIELD OF THE INVENTION

The present invention relates to an arrangement for merchandise display prongs intended for displaying merchandise in shops and the like and comprising a cantilever arm for carrying the merchandise and a feed device which is displaceable along the arm and provided with a grip part and which is intended, when acted on manually, to displace the merchandise carried by the arm in the forward direction toward its free end for the purpose of bringing about a favorable display of the merchandise.

### BACKGROUND OF THE INVENTION

One disadvantage of many merchandise display prongs used today is that, when the merchandise on the prong begins to run out, it is difficult for the customer to find remaining items of merchandise as a large number of prongs with different types of merchandise are in most cases positioned close together. It has therefore long been desirable for the frontmost of the items of merchandise carried by a prong always to be located as far forward on the prong as possible even if there are only a few items on the prong.

To this end, it has previously been proposed to provide merchandise prongs of this type with a manually maneuvered feed device which can run along the prong. In order for it to be possible to take hold of this device, it has usually been provided with a grip arm extending parallel to and above the prong. In some situations, however, such grip arms can constitute an obstruction for merchandise on, for example, prongs located above and limit inter alia the minimum possible spacing between prongs located one above another.

In order to overcome inter alia this problem, spring-operated feed devices which do not have to be maneuvered manually have been proposed. However, such feed devices are more complicated and more expensive to manufacture and assemble as they consist of more components. They can also be difficult to use for some types of product, such as bags containing loose material.

### THE OBJECT OF THE INVENTION

One object of the present invention is to produce a manual feed device for merchandise on a merchandise prong in the form of a cantilever arm, which device inter alia eliminates the abovementioned disadvantages of previously known arrangements of this type.

The invention is based on the realization that this object can be achieved if the feed device is provided with a grip part which, in the rest position, that is to say when no feeding operation is being performed, does not project from the prong in any direction, but which, for feeding, is simple to take hold of.

In this connection, it is particularly characteristic of an arrangement of the type indicated in the first paragraph that the cantilever arm is in the form of a profiled rail with a groove extending on the underside, that the feed device is guided by the profiled rail and is made with an elongate maneuvering arm, that the maneuvering arm runs in a protected manner in the groove in the profiled rail, and that a guide element for the maneuvering arm is arranged at the front end of the profiled rail.

An arrangement of this type achieves inter alia the abovementioned object of, in the rest position, not constituting an obstruction for merchandise on the prong or on adjacent prongs and thus does not limit how closely the prongs can be positioned.

It is preferred that the guide element is made with a guide groove or a through opening for guiding the maneuvering arm. The maneuvering arm is suitably made in such a way that its outer end is located in a protected manner under the outer end of the profiled rail when the feed device is located in a pushed-in rest position.

Further features of the invention emerge from the following patent claims.

The invention will be described in greater detail below with reference to the embodiment shown by way of example in the accompanying drawings.

### BRIEF DESCRIPTION OF THE DRAWING FIGURES

FIG. 1 shows a perspective view of a first embodiment of a merchandise display prong with a feed device according to the invention in rest position.

FIG. 2 is a longitudinal section through the merchandise prong according to FIG. 1.

FIG. 3 is a cross section through the merchandise prong according to FIG. 1.

FIG. 4 shows the merchandise prong according to FIG. 1 with the feed device in the pulled-out position.

FIGS. 5 and 6 illustrate the mounting of interchangeable feed plates on a slide running on the prong according to FIG. 1.

FIG. 7 shows a perspective view of a second embodiment of a merchandise display prong.

FIG. 8 shows the prong in FIG. 7 with the feed device in partly pulled-out position.

FIGS. 9-17 show components forming part of the arrangement according to FIG. 7.

### DETAILED DESCRIPTION OF THE PREFERRED EMBODIMENT

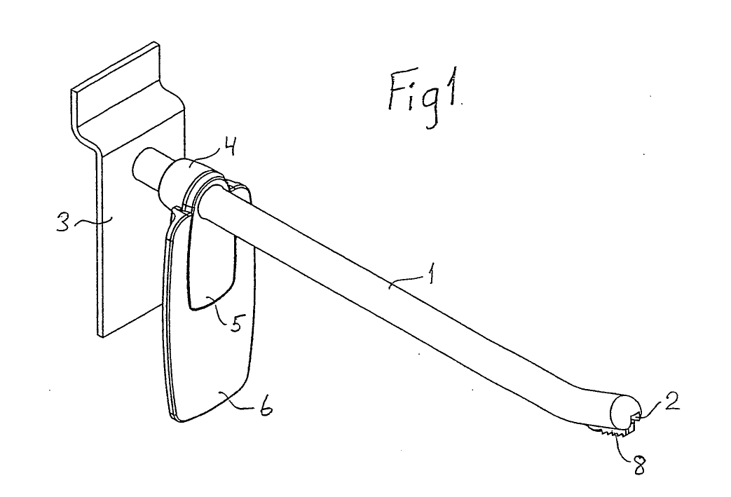

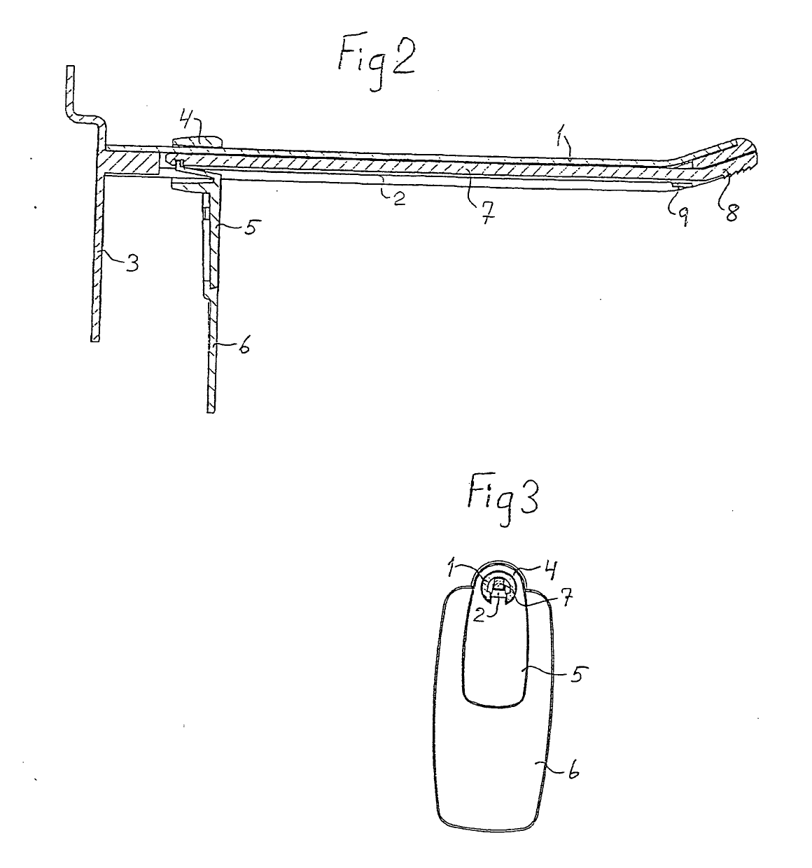

FIG. 1 shows a merchandise display prong comprising a circular cylindrical profiled rail 1 made of aluminum with an inner, downwardly open groove 2 (see also FIGS. 2 and 3). The rear end portion of the prong is connected to a mounting element 3 for mounting on a supporting structure.

A slide 4, which surrounds the rail and has a part 5 on which a feed plate 6 intended to make contact with the merchandise on the rail is mounted, runs on the profiled rail 1. The slide 4 is maneuvered by means of a maneuvering arm 7 with an outer grip part 8, which arm runs in the groove 2 in the rail 1. In the inner, rest position of the feed device, both the arm 7 and the grip part 8 are located in a concealed, protected position in the groove 2 of the profiled rail 1. This means that they do not hinder the removal of merchandise from or the arrangement of merchandise on the prong or prongs located above or below it. The risk of the maneuvering arm 7 catching on people passing by is also eliminated. The maneuvering arm and the grip part take up no extra space as the maneuvering arm runs inside the profiled rail 1.

Arranged at the outer end of the rail 1 is a guide element 9 which, in this embodiment, is made with a through opening for passage and guidance of the elongate maneuvering arm 7. As the front end of the rail is angled up, the grip part 8 of the arm 7 suitably has a corresponding angle, while the guide 9 can have an essentially horizontal hole, which means that the grip part 8 can be arranged in an easily accessible manner.

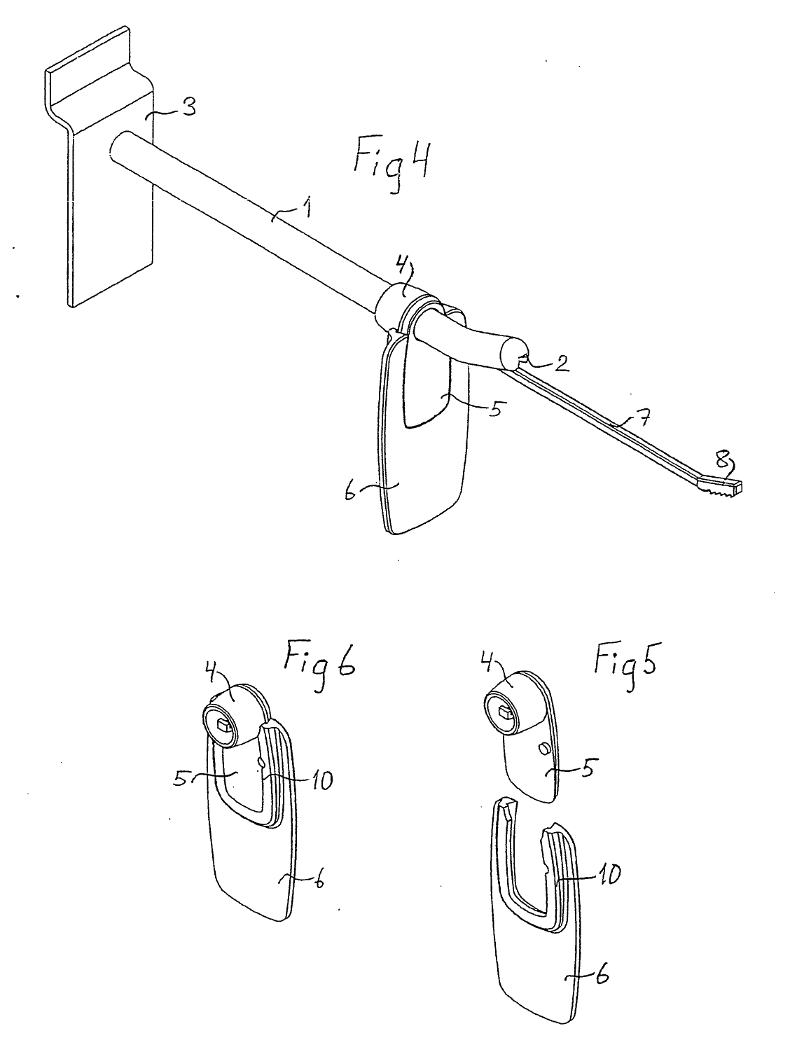

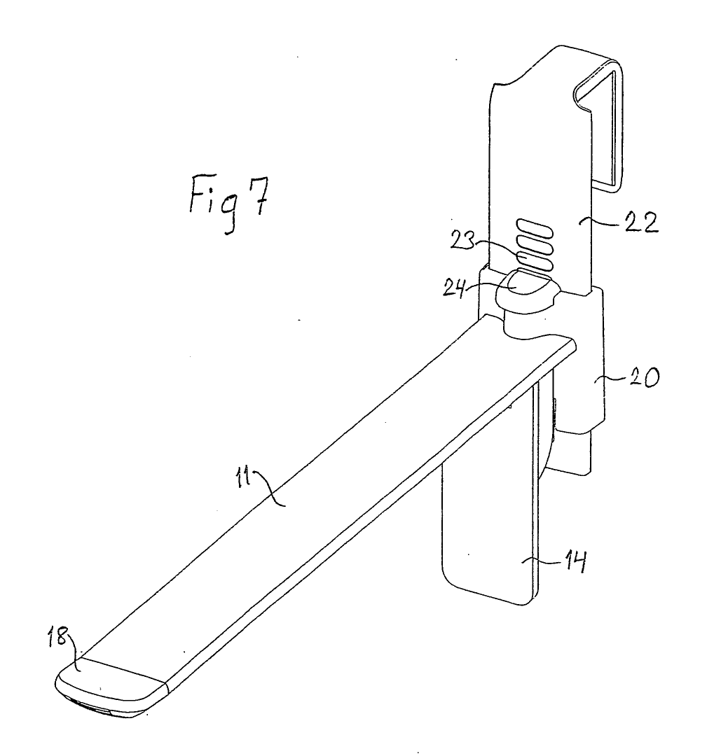

When it is necessary to feed the merchandise carried by the prong toward its front end, it is easy, by means of the grip 8, to pull out the maneuvering arm 7 with the feed plate 6 toward the position shown in FIG. 4 depending on the amount of merchandise on the prong. The feed plate is then returned to its inner, rest position by means of the maneuvering arm.

FIG. 5 shows the slide 4, which runs on the profiled rail 1, with a mounting part 5 and a feed plate 6 mounted thereon. FIG. 6 illustrates how the feed plate 6 can be separated from the mounting part 5 and exchanged for another plate, provided that this has the same U-shaped attachment means 10 for mounting on the part 5. In this way, use can be made of feed plates 6 with size and shape adapted to the products to be displayed on the prong.

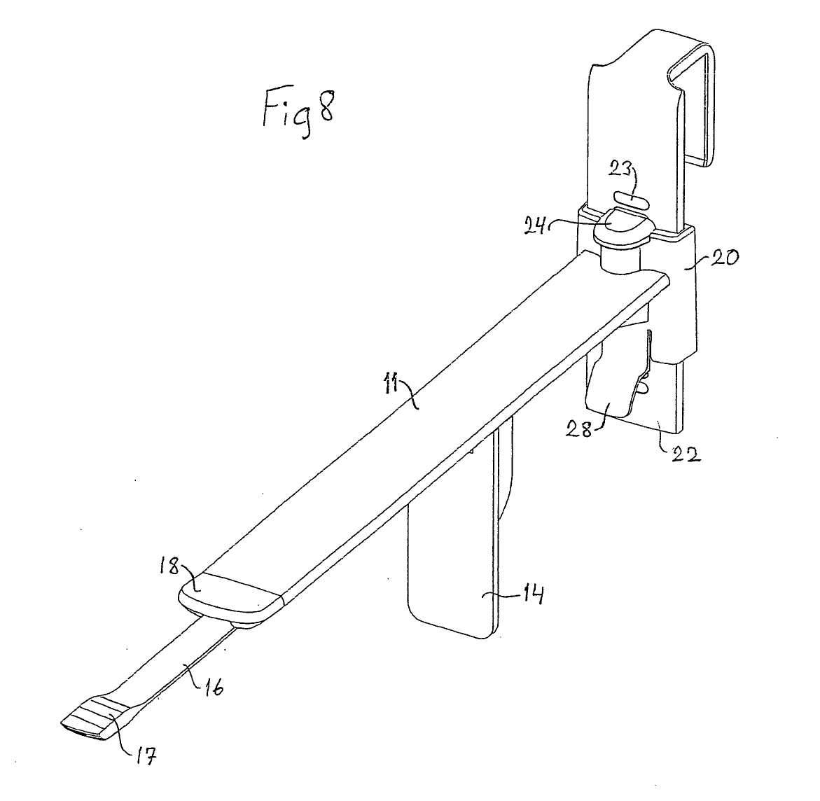

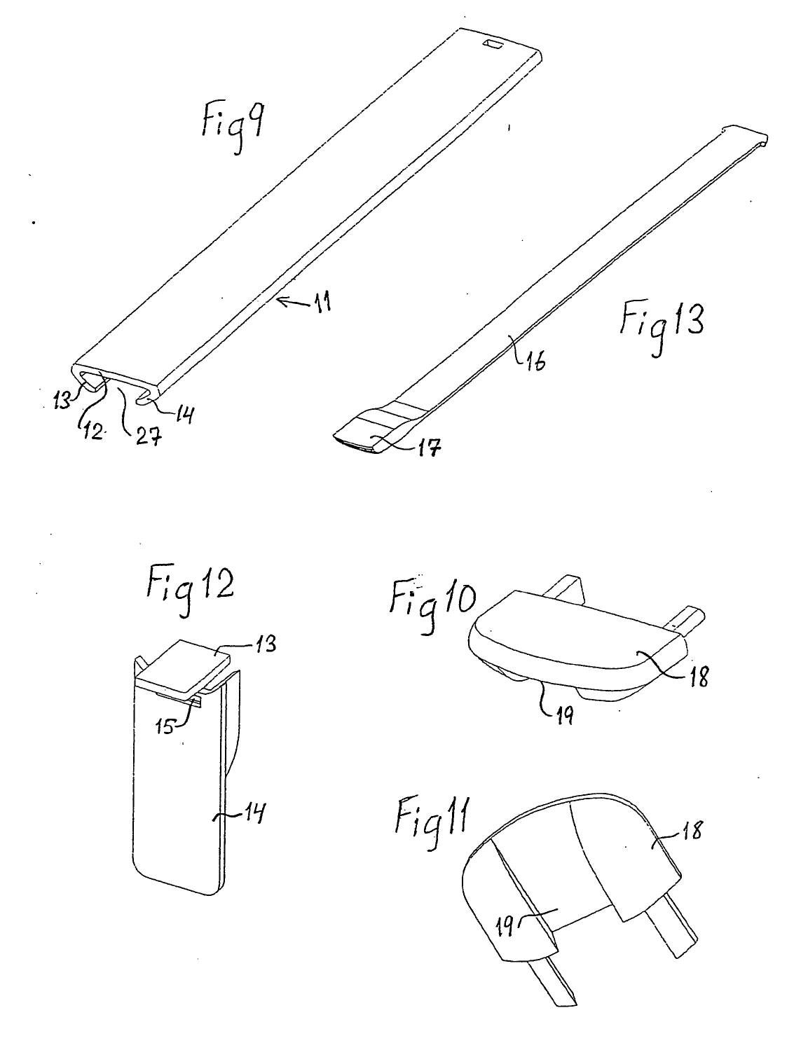

FIGS. 7 and 8 show a second embodiment of a merchandise prong according to the invention with a profiled rail 11 made of aluminum with a plane upper surface. As can be seen from FIG. 9, the profiled rail 11 has an essentially plane web portion 12 and, projecting downward along the edges of this, two flanges 13, 14 which are angled in toward one another so as to form between themselves and the web portion 12 a guide groove 27, for a feed device according to FIG. 12. This comprises a slide 13 which fits in the groove and a feed plate 14 projecting downward from this. At the top, the plate 14 is provided with an opening 15, through which a maneuvering arm 16 with a front grip part can pass (see FIG. 13).

Mounted at the front end of the profiled rail 11 is a guide for the maneuvering arm 16 in the form of a rounded end portion 18 with a guide groove 19 adapted to the maneuvering arm (see FIGS. 10 and 11). The guide groove 19 is made in such a way that it holds the maneuvering arm in place both in the rest position and when it moves.

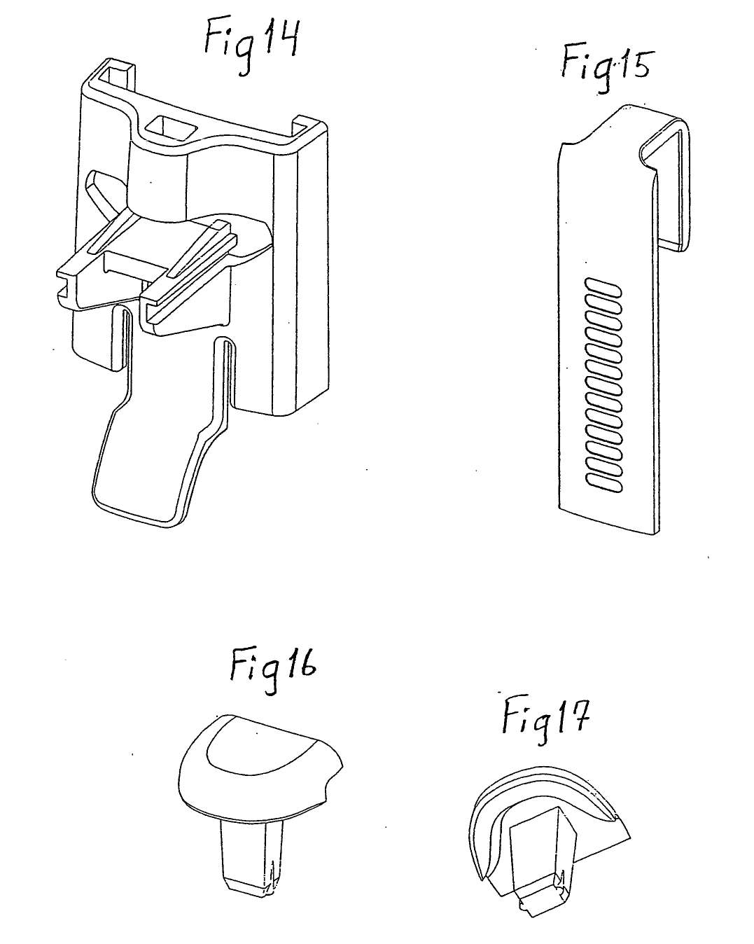

In this embodiment, the profiled rail 11 is attached to a mounting device in the form of a slide 20 with an attachment means 21 which fits in the groove 27 in the profiled rail (see FIG. 14). For locking the profiled rail 11 on the attachment means 21, a plug 24 according to FIGS. 16 and 17 is guided down into the opening 25 in the slide 20 for engagement in the hole 26 in the rear portion of the profiled rail 11. The slide 20 can be displaced in the vertical direction on an adjustment bar 22 with recesses 23 for different adjustment positions (see FIG. 15). In FIGS. 7 and 8, which show the feed device 14 in different positions, the profiled rail 11 has been shown in different vertical positions. By means of a maneuvering tongue 28, the engagement between an engagement means (not shown) and the recesses 23 in the bar 22 can be released during adjustment of the vertical position of the slide 20.

The embodiment of a merchandise prong according to the invention shown in FIGS. 7 and 8 also has the abovementioned advantages of an easily maneuverable feed device, which is maneuvered by means of a manually operable maneuvering arm with a grip part, which, in the rest position, is located in a completely concealed, protected manner in the profiled rail.

The invention has been described above in connection with the embodiments shown in the drawings. However, these can be varied in different respects within the scope of the following patent claims. Profiled rails of different cross section can therefore also be used. In other respects as well, the detailed design of component parts can be varied as desired and depending on the application concerned.

1. An arrangement for merchandise display prongs intended for displaying merchandise in shops and the like and comprising a cantilever arm for carrying the merchandise and a feed device which is displaceable along the arm and provided with a grip part and which is intended, when acted on manually, to displace the merchandise carried by the arm in the forward direction toward its free end for the purpose of bringing about a favorable display of the merchandise, characterized in that the cantilever arm is in the form of a profiled rail with a groove extending on the underside, in that the feed device is guided by the profiled rail and is made with an elongate maneuvering arm, in that the maneuvering arm runs in a protected manner in the groove in the profiled rail, and in that a guide element for the maneuvering arm is arranged at the front end of the profiled rail.

2. The arrangement as claimed in claim 1, characterized in that said guide element is made with a through guide opening or a guide groove for said grip part.

3. The arrangement as claimed in claim 1, characterized in that the grip part is made in such a way that its outer end is located in a protected manner under the outer end of the profiled rail when the feed device is located in a pushed-in rest position.

4. The arrangement as claimed in claim 1, characterized in that the profiled rail has a circular cylindrical lateral surface, and in that the feed device is mounted on a slide which surrounds said rail.

5. The arrangement as claimed in claim 1, characterized in that the feed device comprises a mounting part which is connected to the slide and on which interchangeable feed plates can be mounted.

6. The arrangement as claimed in claim 1, characterized in that the profiled rail has an essentially plane web portion and, projecting downward along the edges of this, two flanges which are directed obliquely inward to form a guide groove for guiding a slide connected to the feed device and for protecting the maneuvering arm connected to the slide.

7. The arrangement as claimed in claim 1, characterized in that the profiled rail is, at its attachment end, attached to a slide which can be displaced between and locked in different positions on a mounting means for adjustment of the position of the profiled rail in the vertical direction.
